(19) United States
(12) Patent Application Publication
(10) Pub. No.: US 2015/0219801 A1
(43) Pub. Date: Aug. 6, 2015

(54) MANUFACTURING METHOD FOR A GLASS THAT HAS AN ANTIREFLECTION PROPERTY AND GLASS THAT HAS AN ANTIREFLECTION PROPERTY

(71) Applicant: Asahi Glass Company, Limited, Tokyo (JP)

(72) Inventors: Takashi SHIBUYA, Tokyo (JP); Naoki OKAHATA, Tokyo (JP)

(73) Assignee: Asahi Glass Company, Limited, Tokyo (JP)

(21) Appl. No.: 14/686,131

(22) Filed: Apr. 14, 2015

Related U.S. Application Data
(63) Continuation of application No. PCT/JP2013/077845, filed on Oct. 11, 2013.

(30) Foreign Application Priority Data
Oct. 17, 2012 (JP) 2012-229518

(51) Int. Cl. G02B 1/18; G02B 1/118; G02B 1/111

(52) U.S. Cl. CPC G02B 1/18; G02B 1/111; G02B 1/118

(57) ABSTRACT

A manufacturing method for a glass that has an antireflection property includes (a) a step of causing a process gas that includes a fluorine compound to contact a surface of a glass substrate within a temperature range of 250° C.-650° C. under an air atmosphere at an ordinary pressure, and (b) a step of forming a layer of an organic fluorine-containing compound on the surface.

### CROSS-REFERENCES TO RELATED APPLICATIONS

The present application is a continuation application of International Application No. PCT/JP2013/077845 filed on Oct. 11, 2013 and designated the U.S., the entire contents of which are herein incorporated by reference, and which is based upon and claims the benefit of priority to Japanese Patent Application No. 2012-229518 filed on Oct. 17, 2012, and the entire contents of which are herein incorporated by reference.

### BACKGROUND OF THE INVENTION

1. Field of the Invention

At least one aspect of the present invention relates to a manufacturing method for a glass that has an antireflection property and a glass that has an antireflection property.

2. Description of the Related Art

A high light transmittance may be required for various kinds of glass products such as, for example, a glass for building material, a glass for a display panel, an optical element, a glass for a solar cell panel, a shop window glass, an optical glass, and an eyeglass lens. In such a case, a glass substrate that has an antireflection property is used.

It is possible to configure such a glass substrate that has an antireflection property by, for example, coating a surface of a glass substrate with a low-refractive-index material due to a dipping method, or forming a multilayer film on a surface of a glass substrate due to a dry method such as a vapor deposition method or a sputtering method.

As described previously, a glass substrate with an antireflection film formed on a surface thereof due to various kinds of methods is used in a case where a glass product with a high light transmittance being required is manufactured.

Meanwhile, as such a glass product with an antireflection film formed thereon has been used, dirt such as moisture, oil, a finger print, and/or dust may adhere to a glass surface so as to degrade beauty of the glass product.

For this reason, there is a need for a glass product that has a so-called “antifouling property”, wherein dirt hardly adheres to a surface of a glass substrate even though use thereof is executed for a long period of time.

For example, in order to address such a need, it is considered that a layer of a fluorine-containing compound is placed on a glass surface. It is because a fluorine-containing compound generally has an antifouling property.

However, even in a case where a layer of a fluorine-containing compound is placed on a surface of a glass substrate, it is frequently found that an antifouling effect of such a glass substrate is reduced or lost in a comparatively short period of time. Then, as such a phenomenon occurs, an effect of a placed layer of a fluorine-containing compound is ultimately lost and dirt starts to adhere to a glass substrate again.

### SUMMARY OF THE INVENTION

According to one aspect of the present invention, there is provided a manufacturing method for a glass that has an antireflection property, including (a) a step of causing a process gas that includes a fluorine compound to contact a surface of a glass substrate within a temperature range of 250° C.-650° C. under an air atmosphere at an ordinary pressure, and (b) a step of forming a layer of an organic fluorine-containing compound on the surface.

According to one aspect of the present invention, there is provided a glass that has an antireflection property, including a glass substrate that has a surface thereof, and a layer of an organic fluorine-containing compound formed on the surface, wherein the surface of the glass substrate has a nanometer-order recess or protrusion, and wherein the surface of the glass substrate has a part where a concentration of silicon oxide is lower than that of a bulk thereof and a component other than silicon oxide is abundant.

### BRIEF DESCRIPTION OF THE DRAWINGS

FIG. 1 is a diagram that schematically illustrates a flow of a manufacturing method for an antireflective glass according to one practical example of the present invention.

FIG. 2 is a diagram that illustrates one configuration example of a processing device for executing an etching process for a glass substrate on a condition that the glass substrate is delivered.

FIG. 3 is a cross-sectional diagram that schematically illustrates an antireflective glass according to one practical example of the present invention.

FIG. 4 is a cross-sectional SEM photograph of a glass substrate after an etching process.

### DETAILED DESCRIPTION OF THE EMBODIMENTS

Next, an illustrative embodiment of the present invention will be described below.

(A Manufacturing Method for a Glass that has an Antireflection Property and a Glass that has an Antireflection Property)

An illustrative embodiment of the present invention relates to a glass that has an antireflection property.

An illustrative embodiment of the present invention is made by taking such a problem into consideration, and an illustrative embodiment of the present invention aims to provide a manufacturing method for an antireflective glass with an antifouling property that is maintained for a long period of time. Furthermore, an illustrative embodiment of the present invention aims to provide an antireflective glass that exhibits an antifouling property for a long period of time.

According to an illustrative embodiment of the present invention, a manufacturing method for a glass that has an antireflection property is provided, wherein the manufacturing method is characterized by having (a) a step of causing a process gas that includes a fluorine compound to contact a surface of a glass substrate within a temperature range of 250° C.-650° C. under an air atmosphere at an ordinary pressure, and (b) a step of forming a layer of an organic fluorine-containing compound on the surface.

Herein, in a manufacturing method according to one aspect of an illustrative embodiment of the present invention, the layer of an organic fluorine-containing compound may be formed on the surface by a coating process.

Furthermore, in a manufacturing method according to one aspect of an illustrative embodiment of the present invention, the layer of an organic fluorine-containing compound may include a fluorine-containing polymer and/or a fluorine-containing silane coupling agent.

Furthermore, in a manufacturing method according to one aspect of an illustrative embodiment of the present invention, hydrogen fluoride and/or trifluoroacetic acid may be included as a raw material(s) of the process gas.

Furthermore, in a manufacturing method according to one aspect of an illustrative embodiment of the present invention, the process gas may include hydrogen fluoride and a concentration of the hydrogen fluoride therein may be within an range of 0.1 vol %-10 vol %.

Furthermore, in a manufacturing method according to one aspect of an illustrative embodiment of the present invention, the process gas may further include nitrogen and/or argon.

Furthermore, in a manufacturing method according to one aspect of an illustrative embodiment of the present invention, the glass substrate in the step (a) may contact the process gas in a state of being delivered.

Furthermore, in a manufacturing method according to one aspect of an illustrative embodiment of the present invention, an injector may be arranged on a top of the glass substrate in the step (a) and the process gas may be jetted from the injector toward the glass substrate.

In this case, a passage time of the injector on the glass substrate may be between 1 second-120 seconds.

Furthermore, in a manufacturing method according to one aspect of an illustrative embodiment of the present invention, a contact angle of the layer of an organic fluorine-containing compound with respect to water may be greater than or equal to 90°.

Furthermore, a manufacturing method according to one aspect of an illustrative embodiment of the present invention may have a step of forming a bonding layer on the surface between the steps (a) and (b).

Moreover, according to an illustrative embodiment of the present invention, a glass that has an antireflection property is provided, wherein the glass is characterized by having:

a glass substrate that has a surface thereof; and

a layer of an organic fluorine-containing compound formed on the surface,

wherein the surface of the glass substrate has a nanometer-order recess or protrusion, and

wherein the surface of the glass substrate has a part where a concentration of silicon oxide is lower than that of a bulk thereof and a component other than silicon oxide is abundant.

Herein, a glass according to one aspect of an illustrative embodiment of the present invention may further have a bonding layer between the glass substrate and the layer of an organic fluorine-containing compound.

Furthermore, in a glass according to one aspect of an illustrative embodiment of the present invention, the layer an of organic fluorine-containing compound may include a fluorine-containing polymer and/or a fluorine-containing silane coupling agent.

Furthermore, in a glass according to one aspect of an illustrative embodiment of the present invention, a substrate thickness of the glass substrate may be less than or equal to 3 mm and a transmittance of the glass substrate (a mean value of a transmittance within a wavelength range of 400 nm-700 nm) may be greater than or equal to 88%.

According to an illustrative embodiment of the present invention, it is possible to provide a manufacturing method for an antireflective glass with an antifouling property that is maintained for a long period of time. Furthermore, according to an illustrative embodiment of the present invention, it is possible to provide an antireflective glass that exhibits an antifouling property for a long period of time.

Next, one aspect of an illustrative embodiment of the present invention will be described in detail below, with reference to the drawings.

According to an illustrative embodiment of the present invention, a manufacturing method for a glass that has an antireflection property is provided, wherein the manufacturing method is characterized by having (a) a step of causing a process gas that includes a fluorine compound to contact a surface of a glass substrate within a temperature range of 250° C.-650° C. under an air atmosphere at an ordinary pressure, and (b) a step of forming a layer of an organic fluorine-containing compound on the surface.

As described previously, in a case where a glass product with a required high light transmittance is manufactured, a glass substrate with an antireflection film formed on a surface thereof due to various kinds of methods is used.

On the other hand, dirt such as moisture, oil, a finger print, and/or dust may adhere to a glass surface during use of such a glass product with an antireflection film formed thereon, so that beauty of the glass product may be degraded. For this reason, a glass product that has a so-called “antifouling property” is desired wherein dirt hardly adheres to a surface of the glass product even though use thereof is executed for a long period of time.

Here, in order to address such a need, it is considered that, for example, a layer of a fluorine-containing compound is placed on a glass surface. It is because a fluorine-containing compound generally has an antifouling property.

However, it is frequently found in a study of inventors for the present application that an antifouling effect is reduced or lost in a comparatively short period of time even though a layer of a fluorine-containing compound is placed on a surface of a glass substrate. It is considered that this is because a layer of a fluorine-containing compound is gradually damaged and worn or peeled during use of a glass substrate so that an amount of the fluorine-containing compound that is present on a surface of the glass substrate is reduced. In particular, in a case where an antireflection property is developed on a glass substrate, an antireflection film is formed on a surface of the glass substrate. A film thickness of this antireflection film is usually comparatively small, and for this reason, it is necessary for a surface of a glass substrate to be comparatively flat. It is because, otherwise, it is difficult to coat an entirety of a desired surface of a glass substrate with an antireflection film uniformly at good precision.

However, in a case where a layer of a fluorine-containing compound is formed on a flat surface of a glass substrate, the layer of a fluorine-containing compound more readily causes damage and wear and/or peeling. Furthermore, thereby, a phenomenon as described previously, that is, a problem in that an antifouling effect is reduced or lost in a comparatively short period of time, is more significant.

On the contrary, a glass manufacturing method according to the present embodiment has a feature in such a manner that a glass substrate is first etching-processed with a process gas that includes a fluorine compound and a layer of an organic fluorine-containing compound is subsequently formed on this etching-processed surface.

Because a layer of an organic fluorine-containing compound is formed on a surface of a glass substrate in the present embodiment, it is thereby possible to develop an antifouling property on the glass substrate.

Furthermore, a glass substrate is etching-processed with a process gas instead of an as-conventional antireflection film, and thereby, a fine recess or protrusion is formed on a surface of the glass substrate, thereby developing an antireflection property on the glass substrate.

In this case, a layer of an organic fluorine-containing compound is not placed on a flat surface of a glass substrate but placed on a surface with many fine or nm-order recesses or protrusions formed by an etching process in a previous process. For this reason, damage and wear and/or peeling of a layer of an organic fluorine-containing compound during use is comparatively unlikely to occur in the present embodiment, and it is possible to maintain an antifouling property for a long period of time.

Due to the above effect, it is possible for a manufacturing method according to the present embodiment to provide an antireflective glass with an antifouling property that persists for a long term.

Here, an “etching process” in the present application means a process that uses a process gas to develop an antireflection property on a surface of a glass substrate, regardless of a practical amount of etching. Therefore, for even a process with an extremely small amount of etching (for example, a process at a level for forming a 0.1 nm-200 nm order recess or protrusion), such a process is, in practice, included in an “etching process” as long as an antireflection property is developed on a surface of a glass substrate. For this meaning, an “etching process” may be expressed as an “antireflection property providing process” with a process gas.

Furthermore, a “nm-order recess or protrusion” refers to a recess or protrusion of 1 μm or less, preferably 500 nm or less, and more preferably 300 nm or less. However, presence of a recess or protrusion with 1 nm or less is not excluded as long as an effect in the present application is not impaired.

(For a Manufacturing Method According to One Practical Example of the Present Invention)

Next, a manufacturing method for an antireflective glass according to one practical example of the present invention will be described in detail with reference to the drawings.

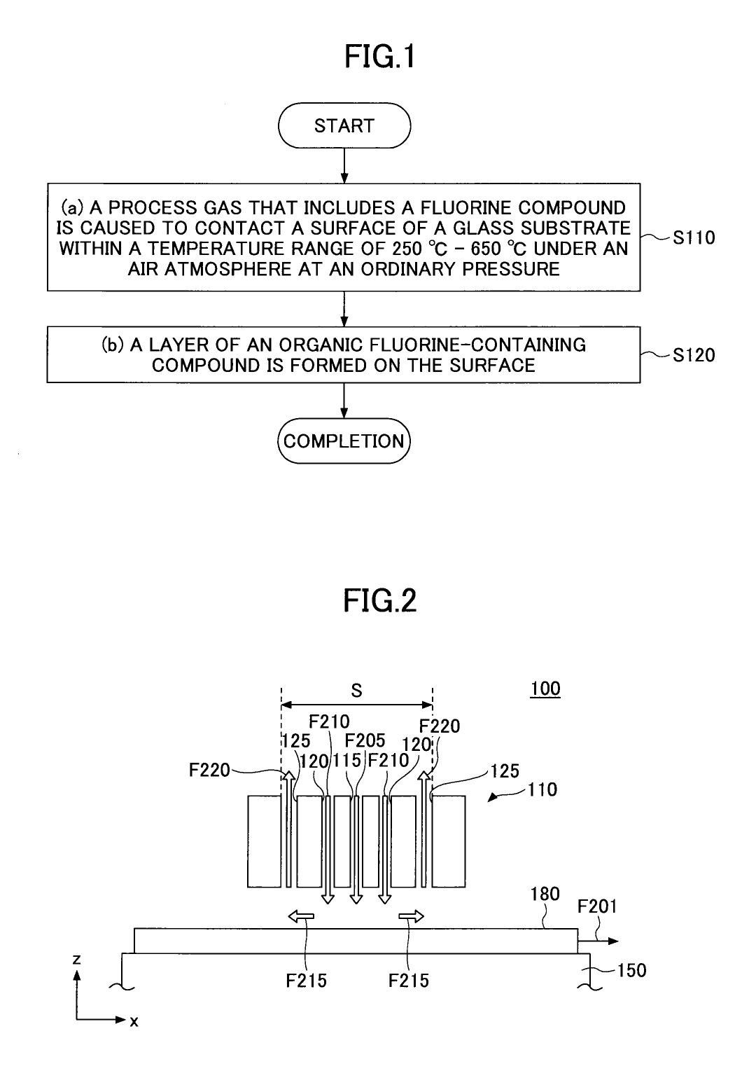

FIG. 1 schematically illustrates a flow of a glass manufacturing method according to one practical example of the present invention.

As illustrated in FIG. 1, a glass manufacturing method according to one practical example of the present invention has:

(a) a step (step S110) of causing a process gas that includes a fluorine compound to contact a surface of a glass substrate within a temperature range of 250° C.-650° C. under an air atmosphere at an ordinary pressure; and

(b) a step (step S120) of forming a layer of an organic fluorine-containing compound on the surface.

Each step will be described below.

(Step S110)

First, a glass substrate is prepared.

A kind of a glass substrate is not particularly limited. For a glass substrate, it is possible to use a transparent glass substrate that is composed of, for example, a soda lime glass, a soda lime silicate glass, an aluminosilicate glass, a borate glass, a lithium aluminosilicate glass, a quartz glass, a borosilicate glass, an alkali-free glass, and other or various kinds of glasses.

In particular, it is preferable for a glass substrate to include an alkali element, an alkaline-earth element, and/or aluminum, such as a soda lime silicate glass or an aluminosilicate glass.

In a case where a glass substrate includes an alkali element, an alkaline-earth element, and/or aluminum, a fluorine compound readily remains on a surface of the glass substrate after an etching process.

Such a remaining fluorine compound contributes to improvement of a light transmittance of a glass substrate. That is, a refractive index (n₁) of a remaining fluorine compound usually has a refractive index between a refractive index (n₂) of a glass substrate and a refractive index (n₀) of air. For this reason, a glass substrate, a fluorine compound, and air are arranged in this order, and thereby, a total reflectance is lowered so that a light transmittance of the glass substrate is improved consequently.

It is preferable for a glass substrate to have a high transmittance in a wavelength region of 350 nm-800 nm, for example, a transmittance greater than or equal to 80%. Furthermore, it is desirable for a glass substrate to have a sufficient insulating property and a high chemical and/or physical resistance.

A manufacturing method for a glass substrate is not particularly limited. A glass substrate may be manufactured by, for example, a float method.

A thickness of a glass substrate is not particularly limited, and may be, for example, within a range of 0.1 mm-12 mm.

Here, a glass substrate is not necessarily planar and a glass substrate may be curved or deformed, or may be, for example, a glass that is referred to as a “template” wherein a pattern of a molding roller surface at a time of glass molding is formed on a surface thereof.

Then, a glass substrate is exposed to a process gas that includes a fluorine compound to execute an etching process for the glass substrate. This etching process is executed under an air atmosphere at an ordinary pressure.

This process is executed to form a fine, for example, 0.1 nm-200 nm order recess or protrusion on a surface of a glass substrate. Due to presence of such a fine recess or protrusion, an antireflection property is provided for such a glass substrate.

An etching process is executed within a range of 250° C.-650° C. It is preferable for a process temperature to be within a range of 275° C.-600° C., wherein it is more preferable to be within a range of 300° C.-600° C.

A kind of a fluorine compound to be used for an etching process is not particularly limited as long as a gas includes hydrogen fluoride at a time of etching on a glass surface. A raw material of a process gas that includes a fluorine compound may be, for example, hydrogen fluoride and/or trifluoroacetic acid. Hydrogen fluoride or trifluoroacetic acid is non-explosive, and hence, preferable from the viewpoint of safety. Trifluoroacetic acid is thermally decomposed depending on a temperature of a glass surface to generate hydrogen fluoride.

A process gas may include a carrier gas other than a fluorine compound. For example, nitrogen and/or argon, or the like is used but a carrier gas is not limited thereto. Water may be included therein.

A concentration of a fluorine compound in a process gas is not particularly limited as long as a surface of a glass substrate is etching-processed properly. A concentration of a fluorine compound in a process gas is, for example, within a range of 0.1 vol %-10 vol %, wherein it is preferable to be within a range of 0.5 vol %-8 vol % and it is more preferable to be within a range of 1 vol % -5 vol %.

Due to a process with a process gas, a surface of a glass substrate is etched.

Herein, an etching process with a process gas that includes a fluorine compound preferentially eliminates silicon oxide in a glass substrate. Therefore, a concentration of silicon oxide on a surface of a glass substrate after an etching process is less than a bulk thereof whereas a tendency to increase a concentration of a component other than silicon oxide is found.

It is possible to readily confirm such a characteristic by, for example, XPS analysis for a surface of a glass substrate or the like.

Here, an etching process for a glass substrate may be executed on a condition that the glass substrate is delivered. In this case, a more speedy process is possible.

FIG. 2 illustrates one configuration example of a processing device for executing an etching process for a glass substrate on a condition that a glass substrate 180 is delivered. Here, a case where a hydrogen fluoride gas is used as a raw material of a process gas that includes a fluorine compound will be described as one example in the following descriptions.

As illustrated in FIG. 2, this processing device 100 is equipped with an injector 110 and a delivering means 150.

It is possible for the delivering means 150 to deliver the glass substrate 180 mounted on a top thereof in a horizontal direction (X-direction) as illustrated by an arrow F201.

The injector 110 is arranged above the delivering means 150 and the glass substrate 180.

The injector 110 has a plurality of slits 115, 120, and 125 that are flow channels for a process gas.

That is, the injector 110 is equipped with a first slit 115 provided on a central portion thereof in a vertical direction (z-direction), a second slit 120 provided in the vertical direction (z-direction) so as to surround the first slit, and a third slit 125 provided in the vertical direction (z-direction) so as to surround the second slit 120.

One end (top) of the first slit 115 is connected to a (non-illustrated) hydrogen fluoride gas source and the other end (bottom) of the first slit 115 is oriented toward the glass substrate 180. Similarly, one end (top) of the second slit 120 is connected to a (non-illustrated) carrier gas source and the other end (bottom) of the second slit 120 is oriented toward the glass substrate 180. One end (top) of the third slit 125 is connected to an (non-illustrated) exhaust system and the other end (bottom) of the third slit 125 is oriented toward the glass substrate 180.

In a case where an etching process for the glass substrate 180 is executed by using the processing device 100, a hydrogen fluoride gas is first supplied from a (non-illustrated) hydrogen fluoride gas source through the first slit 115 to a direction of an arrow F205. Furthermore, a carrier gas such as nitrogen is supplied from a (non-illustrated) carrier gas source through the second slit 120 to a direction of an arrow F210. Such a gas is moved in a horizontal direction (x-direction) or according to an arrow F215, and subsequently, exhausted, by an exhaust system, through the third slit 125 toward an exterior of the processing device 100.

Here, a carrier gas in addition to hydrogen fluoride may simultaneously be supplied to the first slit 115.

The glass substrate 180 is delivered by the delivering means 150 in a direction of an arrow F201.

The glass substrate 180 passes through a lower side of the injector 110, and at that time, contacts a process gas (a hydrogen fluoride gas and a carrier gas) supplied from the first slit 115 and the second slit 120. Thereby, a surface of the glass substrate 180 is etching-processed.

Here, a process gas supplied onto a surface of the glass substrate 180 moves according to an arrow F215 and is used for an etching process, and subsequently, moves according to an arrow F220 and is exhausted through the third slit 125 connected to an exhaust system to an exterior of the processing device 100.

As the processing device 100 is used, it is possible to execute an etching process for a surface with a process gas while a glass substrate is conveyed. In this case, it is possible to improve an efficiency of processing as compared with a method for executing an etching process by using a reaction container. Furthermore, in a case where the processing device 100 is used, it is also possible to apply an etching process to a glass substrate with a large size.

Herein, a rate of supply of a process gas to the glass substrate 180 is not particularly limited. A rate of supply of a process gas may be, for example, within a range of 5 SLM-1000 SLM (a volume (liter) per minute of a gas at a normal state).

Furthermore, a speed of delivery of the glass substrate 180 is, for example, 1 m/minute-20 m/minute.

Furthermore, a passage time of the injector 110 with respect to the glass substrate 180 is within a range of 1 second-120 seconds, wherein it is preferable to be within a range of 5 seconds-60 seconds and it is more preferable to be within a range of 5 seconds-30 seconds. A passage time of the injector 110 with respect to the glass substrate 180 is less than or equal to 120 seconds, and thereby, it is possible to execute a speedy etching process.

Herein, a “passage time of the injector 110” means a period of time when a predetermined area of the glass substrate 180 passes by a distance S in FIG. 2. Here, a distance S is defined as a distance between an upstream end of a slit (the slit 125 in an example of FIG. 2) at a most upstream side of the injector 110 and a downstream side of a slit (the slit 125 in the example of FIG. 2) at a most downstream side thereof in a direction of delivery of the glass substrate 180.

Thus, as the processing device 100 is used, it is possible to execute an etching process for a glass substrate on a delivery condition.

Here, the processing device 100 illustrated in FIG. 2 is merely one example, and an etching process for a glass substrate with a process gas that includes a hydrogen fluoride gas may be executed by using another device. For example, the glass substrate 180 moves relative to the injector 110 at rest in the processing device 100 in FIG. 2. However, on the contrary thereto, an injector may be moved relative to a glass substrate at rest in a horizontal direction. Alternatively, both a glass substrate and an injector may be moved in mutually opposite directions.

Furthermore, the injector 110 in the processing device 100 in FIG. 2 has three slits 115, 120, and 125 in total. However, the number of slits is not particularly limited. For example, the number of slits may be two. In this case, one slit may be utilized for supply of a process gas (a mixed gas of a carrier gas and a hydrogen fluoride gas) and the other slit may be utilized for exhaust thereof.

Moreover, the injector 110 in the processing device 100 in FIG. 2 is such that the second slit 120 is arranged so as to surround the first slit 115 and the third slit 125 is provided so as to surround the first slit 115 and the second slit 120. However, instead thereof, a first slit, a second slit, and a third slit may be aligned in a horizontal direction (x-direction). In this case, a process gas moves on a surface of a glass substrate in one direction and is subsequently exhausted through a third slit.

Due to the above process, it is possible to provide a glass substrate with an antireflection property.

(Step S120)

Then, a layer of an organic fluorine-containing compound is placed on an etching surface of a glass substrate processed in the aforementioned process.

A method for placement of a layer of an organic fluorine-containing compound is not particularly limited. For example, a layer of an organic fluorine-containing compound may be placed onto an etching surface of a glass substrate by a coating method. For example, an application method, a dipping method, or the like may be used for a coating method.

For one example, a method for placing a layer of an organic fluorine-containing compound on a surface of a glass substrate in accordance with an application method will be described below.

In this case, as provided below, a solution that includes an organic fluorine-containing compound is first prepared and a layer of an organic fluorine-containing compound is formed by using such a solution.

(Preparation of a Solution)

First, a solution that is applied onto a surface of a glass substrate is prepared.

A solution includes an organic fluorine-containing compound and a solvent.

An organic fluorine-containing compound may include, for example, a fluorine-containing polymer and/or a fluorine-containing silane coupling agent.

For a fluorine-containing polymer, there is provided, for example, a polytetrafluoroethylene, a polytrifluoroethylene, a polyvinyl fluoride, a polyvinylidene fluoride, a polyperfluoroalkyl vinyl ether, a polyperfluoropropylene, a polytetrafluoroethylene-perfluoropropylene copolymer, a tetrafluoroethylene-ethylene copolymer, a polyvinyl fluoride-ethylene copolymer, or the like.

Furthermore, such a material may be used wherein a hydroxyl group, an amino group, an epoxy group, a carboxyl group or the like is introduced as a functional group thereof. Moreover, a fluorine-containing polyether, a fluorine-containing poly(meth)acrylate, or the like may be used.

For a representative polyether, there is provided, a perfluoroethylene oxide, a perfluoropropylene oxide, a perfluoromethylene oxide-perfluoropropylene oxide copolymer, a perfluoromethylene oxide-perfluoroethylene oxide copolymer, a perfluoroethylene oxide-perfluoropropylene oxide copolymer, or the like.

Furthermore, a polyether may be a compound that has a carboxyl, hydroxyalkyl, ester, or isocyanate group or the like at a terminal or in a molecular chain of the fluorine-containing polyether described above. Furthermore, for a representative (meth)acrylate, there is provided, a polytrifluoroethyl (meth)acrylate, a polytetrafluoropropyl (meth) acrylate, a polyoctafluoropentyl (meth)acrylate, a polyheptadecafluorodecyl (meth) acrylate, a fluorine-containing (meth)acrylate copolymer, a copolymer of a fluorine-containing (meth)acrylate and another (meth)acrylate, for example, methyl (meth)acrylate, hydroxyethyl (meth)acrylate, a glycidyl (meth)acrylate, or the like, or the like.

These may be mixed and used.

Furthermore, for a fluorine-containing silane coupling agent, there is provided, for example, CF₃(CF₂)₇CH₂CH₂Si(OCH₃)₃, CF₃(CF₂)₇CH₂CH₂SiCl₃, CF₃(CF₂)₇CH₂CH₂Si(CH₃)(OCH₃)₂, CF₃(CF₂)₇CH₂CH₂Si(CH₃)Cl₂, CF₃(CF₂)₅CH₂CH₂SiCl₃, CF₃(CF₂)₅CH₂CH₂Si(OCH₃)₃, CF₃CH₂CH₂SiCl₃, CF₃CH₂CH₂Si(OCH₃)₃, C₈F₁₇SO₂N(C₃H₇)CH₂CH₂CH₂Si(OCH₃)₃, C₇F₁₅CONHCH₂CH₂CH₂Si(OCH₃)₃, C₈F₁₇CO₂CH₂CH₂CH₂Si(OCH₃)₃, CeF₁₇—O—CF(CF₃)CF₂—O—C₃H₆SiCl₃, C₃F₇—O—(CF(CF₃)CF₂—O)₂—CF(CF₃)CONH—(CH₂)₃Si(OCH₃)₃, or the like. These may be used singly or may be mixed and used. Furthermore, a product provided through partial hydrolysis with an acid, an alkali, or the like and condensation may be fabricated preliminarily and used subsequently.

Furthermore, for a silazane compound, there is provided hexamethyldisilazane, CF₃(CF₂)₇CH₂CH₂Si(NH)_{3/2}, or the like. These may be mixed and used. Furthermore, a product provided through partial hydrolysis with an acid, an alkali, or the like and condensation may be fabricated preliminarily and used subsequently.

On the other hand, for a solvent, there is provided, for example, a fluorine-containing solvent, an aliphatic solvent, a ketone-type solvent, an ester-type solvent, or the like.

In addition, a solution may include an additive. For an additive, there is provided, for example, a adhesion accelerating agent, a curing agent, a curing catalyst, or the like.

(Formation of a Layer of an Organic Fluorine-Containing Compound)

Then, a solution as described previously is applied onto a surface of a glass substrate.

An application method is not particularly limited. A solution is applied onto a surface of a glass substrate by using, for example, a spin coat method, a spray coat method, a roller coat method, a flow coat method, or the like.

Subsequently, a solution is dried, and thereby, a layer of an organic fluorine-containing compound is formed on a surface of a glass substrate.

If necessary, a glass substrate may be heat-treated to set a layer of an organic fluorine-containing compound. A maximum temperature for heat treatment may be less than or equal to 200° C.

Thereby, it is possible to form a layer of an organic fluorine-containing compound with a thickness of, for example, 1 nm-100 nm on an etching-processed surface of a glass substrate.

Here, a layer of an organic fluorine-containing compound may be formed directly on an etching-processed surface of a glass substrate, or a bonding layer may be interposed at a lower side of the layer of an organic fluorine-containing compound as another embodiment.

A bonding property between a glass substrate and a layer of an organic fluorine-containing compound is improved by interposing a bonding layer therebetween.

A material of a bonding layer is not particularly limited as long as it is possible to improve such a bonding property thereof. A bonding layer may be composed of, for example, a silane coupling agent such as γ-glycidoxypropyltrimethoxysilane, 3-glycidoxypropyltrimethoxysilane, 2-(3,4-epoxycyclohexyl)ethyltrimethoxysilane, tetramethoxysilane, tetraethoxysilane, and/or γ-aminopropyltrimethoxysilane, or a silazane-type compound such as perhydropolysilazane.

Due to the process provided above, it is possible to manufacture an antireflective glass that has an antifouling property.

Here, an antifouling property of a glass (or a layer of an organic fluorine-containing compound) in the present application is determined based on a contact angle of water on an object surface. That is, it is considered that a surface with a larger contact angle of water provides a better antifouling property.

(For a Glass According to One Practical Example of the Present Invention)

Next, a glass according to one practical example of the present invention will be described with reference to the drawings.

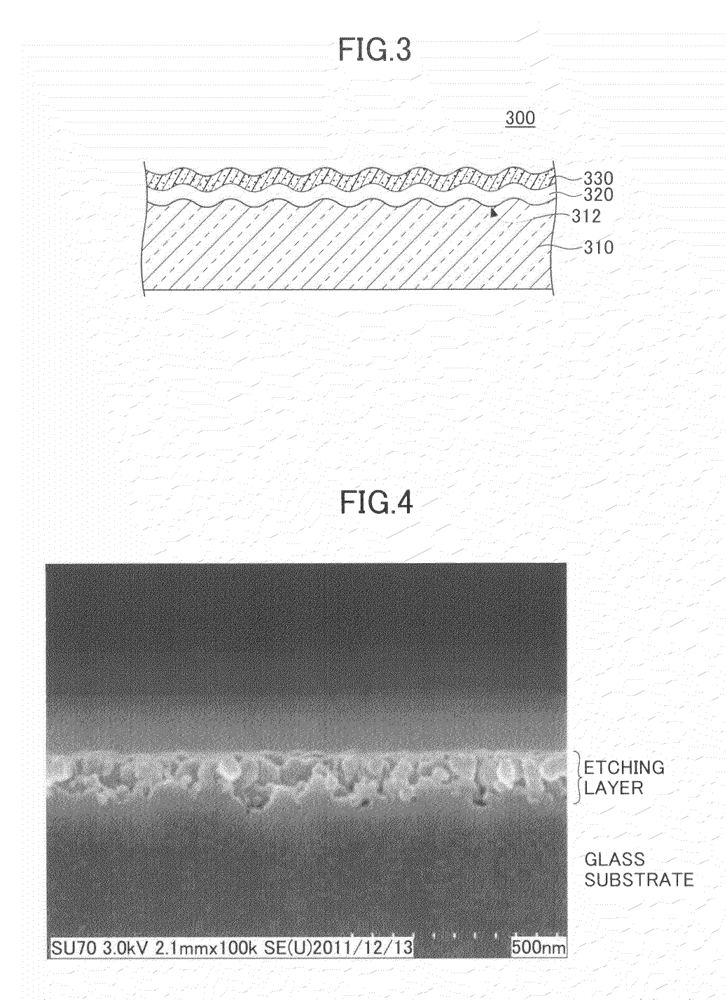

FIG. 3 schematically illustrates a cross section of a glass according to one practical example of the present invention.

As illustrated in FIG. 3, a glass according to one practical example of the present invention has a glass substrate 310, a bonding layer 320, and a layer 330 of an organic fluorine-containing compound. Here, it is necessary to note that FIG. 3 is drawn schematically and does not correspond to a practical scale, wherein a part of members is illustrated exaggeratingly.

The glass substrate 310 has a first surface 312 and the first surface has fine recesses or protrusions. Due to an effect of such a shape of the first surface 312, the glass is provided with an antireflection property.

Furthermore, such a first surface of the glass substrate 310 is such that a concentration of silicon oxide is lower than that of a bulk thereof whereas a concentration of a component other than silicon oxide is higher than that of the bulk thereof.

The bonding layer 320 is placed on the first surface 312 of the glass substrate 310. The bonding layer 320 is placed to improve a bonding property of the layer 330 of an organic fluorine-containing compound with respect to the glass substrate 310.

The bonding layer 320 is not limited thereto but may be composed of, for example, tetraethoxysilane or the like. However, the bonding layer 320 may be omitted.

Here, the bonding layer 320 does not have a surface with a flat shape but is formed so as to have a shape that corresponds to fine recesses or protrusions of a first surface of the glass substrate 310. The bonding layer 320 is provided with such a shape, and thereby, an effect of a shape of the first surface 312 of the glass substrate 310 is maintained, that is, an antireflection property of the glass 300 is maintained.

The layer 330 of an organic fluorine-containing compound is placed on the bonding layer 320. Alternatively, the layer 330 of an organic fluorine-containing compound may be placed on the first surface 312 of the glass substrate 310 in a case where the bonding layer 320 is not present.

The layer 330 of an organic fluorine-containing compound has a thickness of 1 nm-100 nm.

The layer 330 of an organic fluorine-containing compound does not have a surface with a flat shape but is formed so as to have a shape that corresponds to fine recesses or protrusions of a first surface of the glass substrate 310. The layer 330 of an organic fluorine-containing compound is provided with such a shape, and thereby, an effect of a shape of the first surface 312 of the glass substrate 310 is maintained, that is, an antireflection property of the glass 300 is maintained.

Furthermore, an antifouling property of the glass 300 is developed by the layer 330 of an organic fluorine-containing compound.

A transmittance of the glass 300 according to one practical example of the present invention is greater than or equal to 91%. Here, a transmittance in the present application means a mean value of transmittances within a wavelength range of 400 nm-700 nm.

Furthermore, a contact angle of water with respect to the layer 330 of an organic fluorine-containing compound is greater than or equal to 90°. It is preferable for a contact angle of water with respect to the layer 330 of an organic fluorine-containing compound to be greater than or equal to 92°, wherein it is more preferable to be greater than or equal to 95°.

Herein, the layer 330 of an organic fluorine-containing compound is placed on the first surface 312 of the glass substrate 310. This first surface 312 is configured in such a manner that many fine recesses or protrusions have a three-dimensionally complicated and intricate shape. Furthermore, the layer 330 of an organic fluorine-containing compound is formed on a surface of such a three-dimensional fine recess or protrusion structure. For this reason, the glass 300 significantly suppresses wear-or-peeling-caused consumption or loss of the layer of an organic fluorine-containing compound. Furthermore, it is possible to maintain an “antifouling property” for a long period of time thereby.

Due to the characteristic provided above, it is possible for the glass 300 according to one practical example of the present invention to obtain an antireflection property and maintain an “antifouling property” for a long period of time.

Next, practical examples of the present invention will be described.

### Practical Example 1

In accordance with a method provided below, an antireflective glass was manufactured and a characteristic thereof was evaluated.

(An Etching Process)

First, an etching process with an HF gas was executed for a glass substrate (soda lime glass) with a thickness of 3 mm. The aforementioned processing device 100 illustrated in FIG. 2 was used for the etching process.

In the processing device 100, a mixed gas of a hydrogen fluoride gas and a nitrogen gas was supplied to the first slit 115 at a flow rate of 34 cm/sec. An amount of a supplied hydrogen fluoride gas was 1.0 SLM (volume (liter) per minute of a gas at a normal state) and an amount of a supplied nitrogen gas was 31.0 SLM (volume (liter) per minute of a gas at a normal state). Here, the mixed gas was supplied on a condition of being heated to 150° C.

Furthermore, a nitrogen gas was supplied to the second slit 120 at a flow rate of 34 cm/sec. A temperature of the nitrogen gas was 150° C. and an amount of the supplied nitrogen gas was 10 SLM.

A concentration of a hydrogen fluoride gas in an entire supplied gas was 2.4 vol %.

An amount of exhaust from the third slit 125 was two times an amount of a supplied supply gas.

A rate of delivery of the glass substrate was 2 m/min and the glass substrate was delivered on a condition of being heated to 560° C. Here, a temperature of the glass substrate was a value measured by using a radiation thermometer immediately before a process gas was supplied.

An etching process time (a period of time when the glass substrate passed by the distance S in FIG. 2) was about 10 seconds.

FIG. 4 is a cross-sectional diagram of the glass substrate after an etching process that was imaged by using a scanning electron microscope (SEM) (SU70 produced by Hitachi High-Technologies Corporation), and it is found from this diagram that many nm-order recesses or protrusions were formed on a processed surface of the glass substrate after the etching process. The glass substrate at this stage will particularly be referred to a “post-etching glass substrate according to Practical Example 1” below.

A transmittance of the post-etching glass substrate according to Practical Example 1 was measured by using a spectrophotometer (UV-3100: produced by SHIMADZU CORPORATION). A measurement of the transmittance was such that light was incident on an etching-processed surface of the post-etching glass substrate according to Practical Example 1 and an integrating sphere transmittance thereof was measured. A mean value within a wavelength range of 400 nm-700 nm was provided as a transmittance Tₑ.

Then, a similar measurement was executed for a glass substrate wherein the etching process was not executed. An obtained transmittance thereof was provided as T₀.

A transmittance elevation value ΔTₑ (%) caused by the etching process was obtained from a difference (Tₑ−T₀) between both transmittances Tₑ and T₀.

A transmittance elevation value ΔTₑ of the post-etching glass substrate according to Practical Example 1 was 2.0% (Tₑ=92.3% and T₀=90.3%).

(Formation of a Layer of an Organic Fluorine-Containing Compound)

Then, a layer of an organic fluorine-containing compound was formed on a surface of the post-etching glass substrate according to Practical Example 1 obtained by the aforementioned method, in accordance with a method provided below.

The etching-processed surface of the post-etching glass substrate according to Practical Example 1 was spin-coated with a CT-K solution (produced by ASAHI GLASS CO., LTD.). Here, the CT-K solution was such that a polymer of fluorine-containing methacrylic resin (perfluorohexylethyl methacrylate: C6FMA) was dissolved in a fluorine-containing solvent AC6000 (solid content: 2%). Conditions of spin-coating were a rotation frequency of 1000 rpm and 10 seconds.

Subsequently, the post-etching glass substrate according to Practical Example 1 was put into an oven and a drying process was executed at 110° C. for 30 minutes.

Thereby, a layer of an organic fluorine-containing compound was formed on the post-etching glass substrate according to Practical Example 1. Such an obtained glass substrate will be referred to as a “glass according to Practical Example 1” below.

(Evaluation) A measurement of a transmittance was executed by using the glass according to Practical Example 1 in accordance with the aforementioned method. As a result of the measurement, a transmittance T₁ of the glass according to Practical Example 1 was 92.6%. Furthermore, a transmittance elevation value ΔT (=T₁−T₀) of the glass according to Practical Example 1 was 2.3%, wherein a high transmittance was obtained similar to that before the layer of an organic fluorine-containing compound was formed. Thus, it was found that the glass according to Practical Example 1 had a significantly high antireflection property.

Then, a measurement of a contact angle of water was executed by using the glass according to Practical Example 1. The contact angle of water was measured at 30 seconds after 1 μL of distilled water landed onto the layer of an organic fluorine-containing compound in the glass according to Practical Example 1. For the measurement, a contact angle meter (CA-X: produced by Kyowa Interface Science Co., LTD.) was used.

As a result of the measurement, the contact angle of water was 117°. Here, as a similar measurement was executed for the post-etching glass substrate according to Practical Example 1, a contact angle of water was 10°. Therefore, it was confirmed that the layer of an organic fluorine-containing compound was formed, thereby significantly increasing a contact angle and obtaining a water repellency.

Then, a wiping test was executed for the glass according to Practical Example 1.

This wiping test was such that a glass surface was rubbed with a wet fabric 20 times and subsequently a change of a glass characteristic was evaluated. The wiping test was executed by rubbing a side of a surface with the layer of an organic fluorine-containing compound formed in the glass according to Practical Example 1 with a fabric wetted with water (BEMCOT AZ-8: produced by Asahi Kasei Fibers Corporation) 20 times.

After the wiping test, a transmittance Tₐ of the glass according to Practical Example 1 was measured. Furthermore, a transmittance elevation value ΔTₐ (=Tₐ−T₀) was obtained from this transmittance Tₐ. The transmittance elevation value ΔTₐ was 2.0%. Therefore, it was found that the glass according to Practical Example 1 exhibited a good low reflectance even after the wiping test.

Furthermore, as a contact angle of water was measured at a side of the layer of an organic fluorine-containing compound in the glass according to Practical Example 1 after the wiping test, the contact angle was 110°. Therefore, it was found that the glass according to Practical Example 1 exhibited a good water repellency even after the wiping test.

Manufacturing conditions of the glass according to Practical Example 1 and results of evaluations of characteristics of the glass according to Practical Example 1 are collectively illustrated in a column for Practical Example 1 in Table 1 provided below.

TABLE 1

| | Etching process | | |
|---|---|---|---|
| | Process | HF | |
| | temperature | concentration | Process time |
| Example | (° C.) | (%) | (seconds) |
| Practical | 560 | 2.4 | 10 |
| Example 1 | | | |
| Practical | 560 | 2.4 | 10 |
| Example 2 | | | |
| Practical | 560 | 2.4 | 10 |
| Example 3 | | | |
| Comparative | — | — | — |
| Example 1 | | | |

Etching process

| | Transmittance | |
|---|---|---|
| | elevation | Contact angle |
| Example | value ΔTₑ (%) | (°) |
| Practical | 2.0 | 10 |
| Example 1 | | |
| Practical | 2.0 | 10 |
| Example 2 | | |
| Practical | 2.0 | 10 |
| Example 3 | | |
| Comparative | 0.0 | 6 |
| Example 1 | | |

| | Application | Rotation | Time |
|---|---|---|---|
| Example | fluid | frequency (rpm) | (seconds) |
| Practical | CT-K | 1000 | 10 |
| Example 1 | | | |
| Practical | CT-K | 2000 | 20 |
| Example 2 | | | |
| Practical | OPTOOL DSX | 2000 | 20 |
| Example 3 | | | |
| Comparative | CT-K | 1000 | 10 |
| Example 1 | | | |

| | Organic fluorine-containing compound formation | | |
|---|---|---|---|
| | process | | |
| | | Transmittance | |
| | Transmittance | elevation value | Contact angle |
| Example | T (%) | ΔT (%) | (°) |
| Practical | 92.6 | 2.3 | 117 |
| Example 1 | | | |
| Practical | 92.5 | 2.2 | 118 |
| Example 2 | | | |
| Practical | 92.5 | 2.2 | 120 |
| Example 3 | | | |
| Comparative | 90.8 | 0.5 | 105 |
| Example 1 | | | |

After wiping test

| | Transmittance | |
|---|---|---|
| | elevation | Contact angle |
| Example | value ΔTₐ (%) | (°) |
| Practical | 2.0 | 110 |
| Example 1 | | |
| Practical | 2.0 | 105 |
| Example 2 | | |
| Practical | 2.0 | 115 |
| Example 3 | | |
| Comparative | 0.1 | 18 |
| Example 1 | | |

### Practical Example 2

According to a method similar to that of Practical Example 1, a glass according to Practical Example 2 was manufactured and a characteristic thereof was evaluated. However, conditions of spin-coating of a CT-K solution for a glass substrate after an etching process (that will be referred as a “post-etching glass substrate according to Practical Example 2” below) in a process of “(Formation of a layer of an organic fluorine-containing compound)” in this Practical Example 2 were a rotation frequency of 2000 rpm and a period of time of 20 seconds. The other manufacturing conditions were similar to those in the case of Practical Example 1.

Thereby, a “glass according to Practical Example 2” was obtained.

Here, a transmittance elevation value ΔTₑ (%) of the post-etching glass substrate according to Practical Example 2, as calculated by a method similar to that of Practical Example 1, was 2.0% (Tₑ=92.3% and T₀=90.3%).

Then, a measurement of a transmittance was executed by using the glass according to Practical Example 2 in accordance with the aforementioned method. A result of the measurement, a transmittance T₂ of the glass according to Practical Example 2 was 92.5%. Furthermore, a transmittance elevation value ΔT (=T₂−T₀) of the glass according to Practical Example 2 was 2.2%, wherein a high transmittance was obtained similar to that before a layer of an organic fluorine-containing compound was formed. Thus, it was found that the glass according to Practical Example 2 had a significantly high antireflection property.

Then, a measurement of a contact angle of water was executed by using the glass according to Practical Example 2 in accordance with the aforementioned method. As a result of the measurement, the contact angle of water was 118°. Here, as a similar measurement was executed for the post-etching glass substrate according to Practical Example 2, the contact angle of water was 10°. Therefore, it was confirmed that the layer of an organic fluorine-containing compound was formed, thereby significantly increasing a contact angle and obtaining a water repellency.

Then, the aforementioned wiping test was executed for the glass according to Practical Example 2. A transmittance elevation value ΔTₐ after the wiping test was 2.0%. Therefore, it was found that the glass according to Practical Example 2 exhibited a good low reflectance even after the wiping test. Furthermore, as a contact angle of water was measured at a side of the layer of an organic fluorine-containing compound in the glass according to Practical Example 2 after the wiping test, the contact angle was 105°. Therefore, it was found that the glass according to Practical Example 2 exhibited a good water repellency even after the wiping test.

Manufacturing conditions of the glass according to Practical Example 2 and results of evaluations of characteristics of the glass according to Practical Example 2 are collectively illustrated in a column for Practical Example 2 in Table 1 described previously.

### Practical Example 3

According to a method similar to that of Practical Example 1, a glass according to Practical Example 3 was manufactured and a characteristic thereof was evaluated. However, in this Practical Example 3, a layer of an organic fluorine-containing compound was formed on a glass substrate after an etching process (that will be referred to as a “post-etching glass substrate according to Practical Example 3” below) in accordance with the method provided below.

An etching-processed surface of the post-etching glass substrate according to Practical Example 3 was spin-coated with a solution. A used solution was such that an OPTOOL DSX solution (a fluorine-containing silane coupling agent that included a perfluoro group and a hydrolysable silyl group: produced by DAIKIN INDUSTRIES, Ltd.) was diluted to 1% with a fluorine-containing solvent. Conditions of spin-coating were a rotation frequency of 2000 rpm and a period of time of 20 seconds.

Subsequently, the post-etching glass substrate according to Practical Example 3 was put into an oven and a drying process was executed at 120° C. for 30 minutes.

Thereby, a “glass according to Practical Example 3” was obtained.

Here, a transmittance elevation value ΔTₑ (%) of the post-etching glass substrate according to Practical Example 3, as calculated by a method similar to that of Practical Example 1, was 2.0% (Tₑ=92.3% and T₀=90.3%).

Then, a measurement of a transmittance was executed by using the glass according to Practical Example 3 in accordance with the aforementioned method. A result of the measurement, a transmittance T₃ of the glass according to Practical Example 3 was 92.5%. Furthermore, a transmittance elevation value ΔT (=T₃−T₀) of the glass according to Practical Example 3 was 2.2%, wherein a high transmittance was obtained similar to that before the layer of an organic fluorine-containing compound was formed. Thus, it was found that the glass according to Practical Example 3 had a significantly high antireflection property.

Then, a measurement of a contact angle of water was executed by using the glass according to Practical Example 3 in accordance with the aforementioned method. As a result of the measurement, the contact angle of water was 120°. Here, as a similar measurement was executed for the post-etching glass substrate according to Practical Example 3, the contact angle of water was 10°. Therefore, it was confirmed that the layer of an organic fluorine-containing compound was formed, thereby significantly increasing a contact angle and obtaining a water repellency.

Then, the aforementioned wiping test was executed for the glass according to Practical Example 3. A transmittance elevation value ΔTₐ after the wiping test was 2.0%. Therefore, it was found that the glass according to Practical Example 3 exhibited a good low reflectance even after the wiping test. Furthermore, as a contact angle of water was measured at a side of the layer of an organic fluorine-containing compound in the glass according to Practical Example 3 after the wiping test, the contact angle was 115°. Therefore, it was found that the glass according to Practical Example 3 exhibited a good water repellency even after the wiping test.

### Comparative Example 1

According to a method similar to that of Practical Example 1, a glass according to Comparative Example 1 was manufactured and a characteristic thereof was evaluated. However, in this Comparative Example 1, an etching process was not executed for a glass substrate. That is, only the aforementioned “(Formation of a layer of an organic fluorine-containing compound)” process was executed for the glass substrate. The other manufacturing conditions were similar to those in the case of Practical Example 1.

Thereby, a “glass according to Comparative Example 1” was obtained.

Then, a measurement of a transmittance was executed by using the glass according to Comparative Example 1 in accordance with the aforementioned method. As a result of the measurement, a transmittance T₄ of the glass according to Comparative Example 1 was 90.8%. Furthermore, a transmittance elevation value ΔT (=T₄−T₀) of the glass according to Comparative Example 1 was 0.5% (T₀=90.3%).

Then, a measurement of a contact angle of water was executed by using the glass according to Comparative Example 1 in accordance with the aforementioned method.

As a result of the measurement, the contact angle of water was 105°. Here, as a similar measurement was executed for the glass substrate before a layer of an organic fluorine-containing compound was formed, the contact angle of water was 6°.

Then, the aforementioned wiping test was executed for the glass according to Comparative Example 1. A transmittance elevation value ΔTₐ after the wiping test was 0.1%. Furthermore, as a contact angle of water was measured at a side of a layer of an organic fluorine-containing compound in the glass according to Comparative Example 1 after the wiping test, the contact angle was 18°. From this fact, it was found that the glass according to Comparative Example 1 was such that the wiping test caused an effect of a water repellency to be lowered and a good water repellency not to be exhibited.

Manufacturing conditions of the glass according to Comparative Example 1 and results of evaluations of characteristics of the glass according to Comparative Example 1 are collectively illustrated in a column for Comparative Example 1 in Table 1 described previously.

As provided above, it was confirmed that low reflectances and water repellencies of the glasses according to Practical Examples 1-3 were maintained stably.

(Surface analysis)

Next, a sample for analysis was fabricated in a method described below in order to study a surface condition of a glass substrate after an etching process.

First, an etching process with an HF gas was executed for a glass substrate (soda lime glass) with a thickness of 3 mm. The aforementioned processing device 100 illustrated in FIG. 2 was used for the etching process.

In the processing device 100, a mixed gas of a hydrogen fluoride gas and a nitrogen gas was supplied to the first slit 115 at a flow rate of 34 cm/sec. An amount of a supplied hydrogen fluoride gas was 0.7 SLM (volume (liter) per minute of a gas at a normal state) and an amount of a supplied nitrogen gas was 31.3 SLM (volume (liter) per minute of a gas at a normal state). Here, the mixed gas was supplied on a condition of being heated to 150° C.

Furthermore, a nitrogen gas was supplied to the second slit 120 at a flow rate of 34 cm/sec. A temperature of the nitrogen gas was 150° C. and an amount of the supplied nitrogen gas was 10 SLM.

A concentration of a hydrogen fluoride gas in an entire supplied gas was 2.4 vol %.

An amount of exhaust from the third slit 125 was two times an amount of a supplied supply gas.

A rate of delivery of the glass substrate was 2 m/min and the glass substrate was delivered on a condition of being heated to 560° C. Here, a temperature of the glass substrate was a value measured by using a radiation thermometer immediately before a process gas was supplied.

An etching process time (a period of time when the glass substrate passed by the distance S in FIG. 2) was about 10 seconds.

A sample for analysis was obtained by this etching process.

Then, analysis of an etching-processed surface was executed by the sample for analysis. A scanning X-ray photoelectron spectroscopic device (Quantera μESCA: produced by ULVAC-PHI, INCORPORATED) was used for the analysis. The analysis was a narrow scan analysis (pass energy 112 eV) wherein a step energy was 0.1 eV. Furthermore, for comparison, similar analysis was also executed for a similar glass substrate sample wherein an etching process was not applied thereto (that will be referred to as a “comparative sample” below).

Results of analysis obtained for the sample for analysis and the comparative sample are collectively illustrated in Table 2 provided below.

TABLE 2

Sample

| | O1s | F1s | Na1S | Mg1S |
|---|---|---|---|---|
| Sample for analysis | 32.0 | 30.0 | 20.7 | 1.8 |
| Comparative sample | 67.1 | 0.0 | 3.4 | 0.1 |

Sample

| | Al2p | Si2p | Ca2p | Sn3d5 |
|---|---|---|---|---|
| Sample for analysis | 3.0 | 4.4 | 6.1 | 2.0 |
| Comparative sample | 0.7 | 22.9 | 1.6 | 4.2 |

From the results of analysis in Table 2, it was found that concentrations of an Si element (see a column of Si2p) and an O element (see a column of O1s) in a surface of the sample for analysis were lower than those of the comparative sample. From this fact, it was confirmed that a concentration of silicon oxide in a processed surface was significantly lower than that of a bulk thereof due to an etching process with a process gas for a glass substrate. That is, a glass that had an antireflection property was such that a concentration of silicon oxide was different between an etching-processed surface part and a bulk that was not influenced by an etching process.

As a result, a layer with a low refractive index and a high fluorine concentration was formed on a surface part, and thereby, it was possible to contribute to improvement of a low reflectance.

Furthermore, due to a high fluorine concentration of a surface part, an affinity with an organic fluorine-containing compound was increased to improve a bonding property.

### INDUSTRIAL APPLICABILITY

It is possible to utilize an illustrative embodiment of the present invention for, for example, a glass product that has a high light transmittance, for example, a glass for building material, a glass for an automobile, a glass for a display, an optical element, a glass for a solar cell, a shop window glass, an optical glass, an eyeglass lens, and the like.

What is claimed is:

1. A manufacturing method for a glass that has an antireflection property, comprising:
(a) a step of causing a process gas that includes a fluorine compound to contact a surface of a glass substrate within a temperature range of 250° C.-650° C. under an air atmosphere at an ordinary pressure; and
(b) a step of forming a layer of an organic fluorine-containing compound on the surface.

2. The manufacturing method as claimed in claim 1, wherein the layer of an organic fluorine-containing compound is formed on the surface by a coating process.

3. The manufacturing method as claimed in claim 1, wherein the layer of an organic fluorine-containing compound includes a fluorine-containing polymer and/or a fluorine-containing silane coupling agent.

4. The manufacturing method as claimed in claim 1, further comprising:
hydrogen fluoride and/or trifluoroacetic acid as a raw material(s) of the process gas.

5. The manufacturing method as claimed in claim 1, wherein the process gas includes hydrogen fluoride and a concentration of the hydrogen fluoride therein is within an range of 0.1 vol %-10 vol %.

6. The manufacturing method as claimed in claim 1, wherein the process gas further includes nitrogen and/or argon.

7. The manufacturing method as claimed in claim 1, wherein the glass substrate in the step (a) contacts the process gas on a condition of being delivered.

8. The manufacturing method as claimed in claim 1, wherein an injector is arranged on a top of the glass substrate in the step (a) and the process gas is jetted from the injector toward the glass substrate.

9. The manufacturing method as claimed in claim 8, wherein a passage time of the injector on the glass substrate is between 1 second-120 seconds.

10. The manufacturing method as claimed in claim 1, wherein a contact angle of the layer of an organic fluorine-containing compound with respect to water is greater than or equal to 90°.

11. The manufacturing method as claimed in claim 1, further comprising:
a step of forming a bonding layer on the surface between the steps (a) and (b).

12. A glass that has an antireflection property, comprising:
a glass substrate that has a surface thereof; and
a layer of an organic fluorine-containing compound formed on the surface,
wherein the surface of the glass substrate has a nanometer-order recess or protrusion, and
wherein the surface of the glass substrate has a part where a concentration of silicon oxide is lower than that of a bulk thereof and a component other than silicon oxide is abundant.

13. The glass as claimed in claim 12, further comprising:
a bonding layer between the glass substrate and the layer of an organic fluorine-containing compound.

14. The glass as claimed in claim 12, wherein the layer of an organic fluorine-containing compound includes a fluorine-containing polymer and/or a fluorine-containing silane coupling agent.

15. The glass as claimed in claim 12, wherein a substrate thickness of the glass substrate is less than or equal to 3 mm and a transmittance of the glass substrate that is a mean value of transmittances within a wavelength range of 400 nm-700 nm is greater than or equal to 88%.
